(19) United States
(12) Patent Application Publication
(10) Pub. No.: US 2005/0170228 A1
(43) Pub. Date: Aug. 4, 2005

(54) Solid polymer electrolyte fuel cell system and operation method therefor

(75) Inventors: Kazuya Tajiri, State College, PA (US); Ryoichi Shimoi, Kanagawa-ken (JP)

Correspondence Address: FOLEY AND LARDNER;SUITE 500, 3000 K STREET NW, WASHINGTON, DC, 20007, US

(73) Assignee: Nissan Motor Co., Ltd.

(21) Appl. No.: 10/513,409

(22) PCT Filed: Nov. 18, 2003
(86) PCT No.: PCT/JP03/14662

(30) Foreign Application Priority Data
Nov. 28, 2002 (JP) 2002-346409

(51) Int. Cl. H01M 8/10; H01M 8/04

(52) U.S. Cl. 429/30; 429/34; 429/23; 429/13

(57) ABSTRACT

A normal operation of a fuel cell (10, 13, 17, 16, 20) for generating electricity with an electrolyte film (1) interposed between a first electrode (11) supplied with a fuel and a second electrode (12) supplied with an oxidizer, is followed by a shutdown operation in which the second electrode (12) is supplied with the fuel to generate hydrogen ions, andhydrogen ions are activated to move with accompanying water, thus transporting moisture, from the second electrode (12) to the first electrode (11) through the electrolyte film (1), by an electromotive force acting between the first and second electrodes (11, 12), as the force is produced therebetween by supplying the oxidizer to the first electrode (11), or as it is imposed therebetween from an external dc power supply (33).

### TECHNICAL FIELD

The present invention relates to a solid polymer electrolyte fuel cell system and an operation method therefor, and in particular, to a solid polymer electrolyte fuel cell system for mobile applications, such as for use in vehicles or vessels or for portable use, and an operation method therefor.

### BACKGROUND ART

In general, the fuel cell system is constituted with a fuel cell body for causing an electrochemical reaction between a fuel, such as hydrogen, and an oxidizer, such as the air, in presence of a catalyst, to convert chemical energy of the fuel directly into electrical energy.

The fuel cell body includes a fuel electrode, to which the fuel is supplied in a normal operation, and an oxidizer electrode, to which the oxidizer is supplied in the normal operation, having a film of electrolyte interposed therebetween. As this electrolyte film is made of a solid high-polymer, the fuel cell system is called “solid polymer electrolyte fuel cell system”.

In the solid polymer electrolyte fuel cell system as well, the following electrochemical reactions occur at the fuel cell and the oxidizer cell, assuming the fuel to be hydrogen and the oxidizer to be air:
Fuel electrode 2H₂→4H⁺+4e⁻ (1)
Oxidizer electrode 4H⁺+4e³¹ +O₂→2H₂O (2)

At the fuel electrode, by the reaction (1), hydrogen molecules are divided into hydrogen ions and electrons.

Hydrogen ions move in the electrolyte film of solid high-polymer, in a hydrated state with accompanying water molecules (+nH₂O), arriving at the oxidizer electrode.

Electrons are conducted via an external circuit including a load.

At the oxidizer electrode, by the reaction (2), water molecules are produced from hydrogen ions, electrons, and oxygen molecule.

Along the electrochemical reactions above, an electromotive force develops across the fuel and oxidizer electrodes, depending on Gibbs' expression of free energy change.

In the above-noted fuel cell system, it is necessary for the solid high-polymer electrolyte film to have supplied moisture on both sides thereof to hold a water-containing state that allows a maintained mobility of hydrogen ion. It also is necessary, when generating electricity, to supplement the fuel electrode with moisture for hydrogen ions to be accompanied therewith.

Therefore, the fuel is moisturized with water, to be supplied to the fuel electrode.

The oxidizer may also be moisturized, as necessary at the oxidizer electrode, which is supplied with water molecules accompanying hydrogen ions, in addition to water produced along the generation of electricity.

The above-noted system may enter a long shutdown in a low-temperature condition with an ambient temperature below the freezing point of water, where condensed moisturizing water may freeze, blocking diffusion paths of reaction gases (fuel, oxidizer), and lowering the ion mobility of the electrolyte film. Upon a startup from the low-temperature condition, the system may thus experience an impeded diffusion of reaction gases in the electrolyte film and delayed electrochemical reactions, with reduced starting performances.

The following patent material-1 has disclosed a low-temperature starting method that includes, in shutdown of a fuel cell system, supplying dry gases to the fuel electrode and the oxidizer electrode, and heating the fuel cell body to promote vaporization of moisture.

Patent Material-1:

Japanese Patent Application Laying-Open Publication No. 2002-246054 (see page4 and FIG. 2)

### SUMMARY OF THE INVENTION

In the method disclosed in Patent Material-1, in order to remove residual moisture in supply paths and diffusion layers of reaction gases, the dry gas supply and the heating may be extended over a long time, drying the electrolyte film, as well. In addition, the electrolyte film may be over-dried at the fuel electrode side just after startup, resulting in an extended recovery of the performance for electricity generation.

The present invention has been made with such points in view. It therefore is an object of the invention to provide a solid polymer electrolyte fuel cell system and an operation method therefor, allowing unnecessary moisture to be removed from the fuel cell body in a low-temperature startup, leaving mere necessary moisture.

To achieve the object, according to an aspect of the invention, a solid polymer electrolyte fuel cell system comprises a fuel cell configured to generate electricity with an electrolyte film disposed between a first electrode supplied with a fuel and a second electrode supplied with an oxidizer, and a moisture transport system configured to transport moisture from the second electrode to the first electrode through the electrolyte film.

According to another aspect of the invention, an operation method for solid polymer electrolyte fuel cell systems comprises generating electricity with an electrolyte film disposed between a first electrode supplied with a fuel and a second electrode supplied with an oxidizer, and transporting moisture from the second electrode to the first electrode through the electrolyte film.

According to another aspect of the invention, a solid polymer electrolyte fuel cell system comprises a fuel cell configured to generate electricity with an electrolyte film disposed between a first electrode supplied with a fuel and a second electrode supplied with an oxidizer, and a hydrogen ion moving system configured to move hydrogen ions from the second electrode to the first electrode through the electrolyte film.

According to another aspect of the invention, an operation method for solid polymer electrolyte fuel cell systems comprises generating electricity with an electrolyte film disposed between a first electrode supplied with a fuel and a second electrode supplied with an oxidizer, and moving hydrogen ions from the second electrode to the first electrode through the electrolyte film.

### BRIEF DESCRIPTION OF DRAWINGS

The above and additional objects, features, and advantages of the invention will more fully appear when the following best modes for carrying out the invention are read in conjunction with the accompanying drawings, in which:

FIG. 1 is a block diagram of a solid polymer electrolyte fuel cell system according to a first embodiment of the invention;

FIG. 2 is a section of a cell of the fuel cell system of FIG. 1;

FIG. 3 is a flow chart of control actions of the fuel cell system of FIG. 1;

FIG. 4 is a block diagram of a solid polymer electrolyte fuel cell system according to a second embodiment of the invention;

FIG. 5 is a block diagram of a solid polymer electrolyte fuel cell system according to a third embodiment of the invention;

FIG. 6 is a section of a cell of the fuel cell system of FIG. 5;

FIG. 7 is a flow chart of control actions of the fuel cell system of FIG. 5; and

FIG. 8 is a block diagram of a solid polymer electrolyte fuel cell system according to a fourth embodiment of the invention.

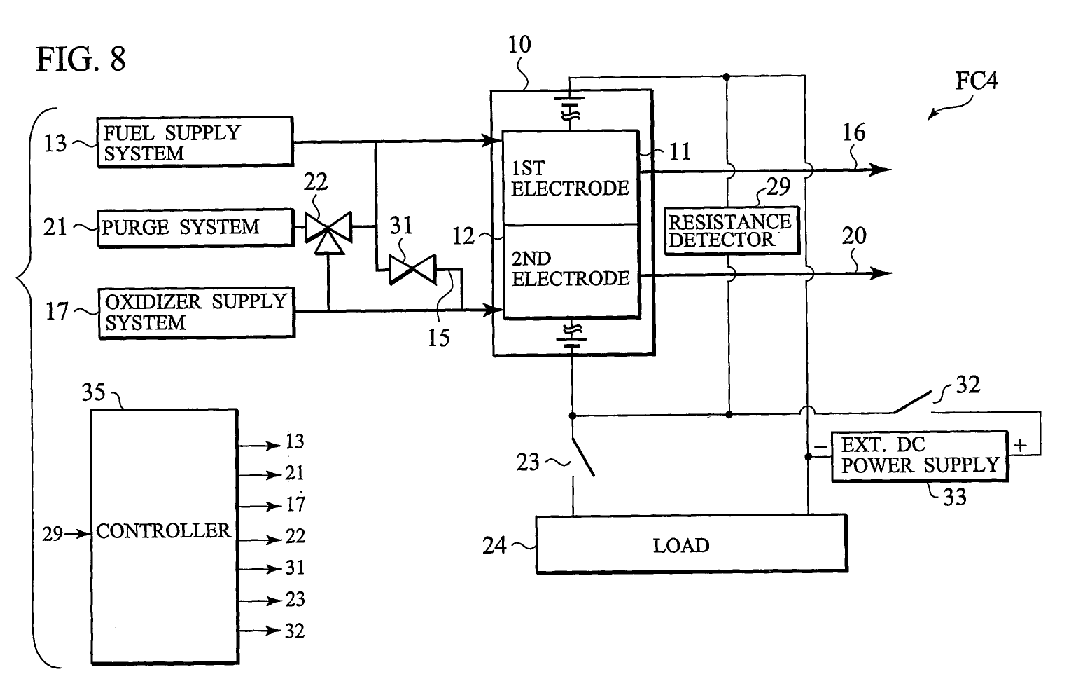

### BEST MODE FOR CARRYING OUT THE INVENTION

As the best mode for carrying out the invention, there will be described below four preferred embodiments with reference to the accompanying drawings. Like members or elements are designated by like reference characters.

### First Embodiment

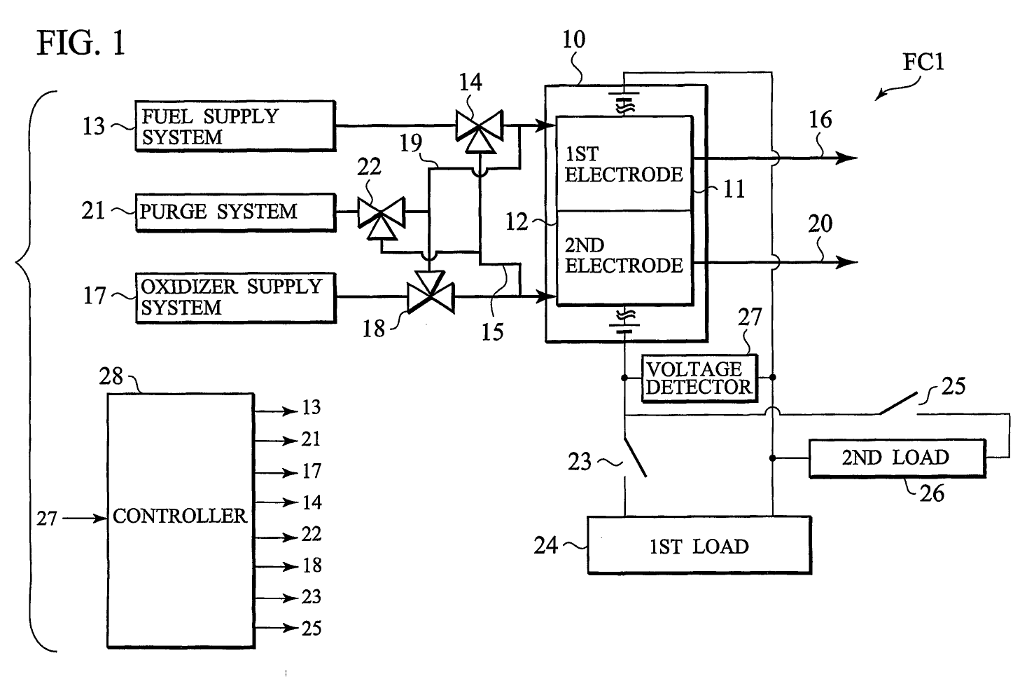

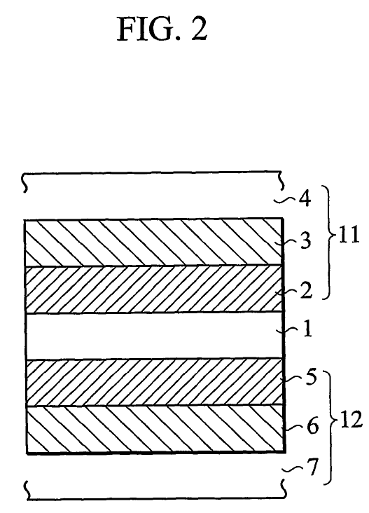

FIG. 1 shows, in block diagram, the arrangement of a solid polymer electrolyte fuel cell system FC1 adapted for outdoor use, in particular to fuel cell vehicles and the like, according to a first embodiment of the invention, and FIG. 2 shows a section of a cell (11/1/12) of a fuel cell body 10 of the fuel cell system FC1.

This system FC1 features performing, after a stop of generation of electricity in a forward polarity, generation of electricity in a reverse polarity to move hydrogen ions in an opposite direction.

That is, at the shutdown of an operation of the system FC1 for the generation of electricity in the forward polarity in which a fuel (hydrogen) is supplied to a first electrode 11 and an oxidizer (air) is supplied to a second electrode 12, gas channels 4, 7 of the first and second electrodes 11, 12 are purged by a purge gas, removing moisture from gas diffusion layers 3, 6, and thereafter, the first electrode 11 is supplied with oxidizer and the second electrode 12 is supplied with fuel, and the generation of electricity in the reverse polarity is performed, having an electric current conducted through a load. Thereby, through a high-polymer electrolyte film 1, hydrogen ions are moved in the opposite direction to the electricity generation in the forward polarity. As those hydrogen ions are accompanied with water molecules, moisture in the second electrode 12 is transported to the first electrode 11.

As shown in FIG. 1, the fuel cell system FC1 includes: the fuel cell body 10, which is made by a plurality of serially connected cells each respectively formed, as shown in FIG. 2, with first and second electrodes 11, 12 and a high-polymer electrolyte film 1 therebetween; a fuel supply system 13, which has a fuel supply line for supplying a fuel (hydrogen) as a reaction gas to a gas inlet of the first electrode 11 of each cell, and an oxidizer supply system 17, which has an oxidizer supply line for supplying an oxidizer (air) as another reaction gas to a gas inlet of the second electrode 12 of each cell.

The gas inlet of the first electrode 11 communicates with a multiplicity of gas channels 4 (of which one is shown at the top of FIG. 2), which further communicate with a gas outlet of the first electrode 11, which is connected to a used gas discharge line 16 in FIG. 1. The gas inlet of the second electrode 12 communicates with a multiplicity of gas channels 7 (of which one is shown at the bottom of FIG. 2), which further communicate with a gas outlet of the second electrode 12, which is connected to a used gas discharge line 20 in FIG. 1.

The fuel supply line of fuel supply system 13 has a three-port solenoid valve installed therein as a fuel branch valve 14, which has a gas inlet port connected to a fuel source, and a pair of selective gas outlet ports connected, either, to the gas inlet of the first electrode 11 of each cell and, the other, via a fuel branch line 15 to the gas inlet of the second electrode 12 of each cell. The fuel source may have a high-pressure hydrogen tank, liquid hydrogen storage tank, or hydrogen absorbing metal tank.

Also the oxidizer supply line of oxidizer supply system 17 has a three-port solenoid valve installed therein as an oxidizer branch valve 14, which has a gas inlet port connected to an oxidizer source, and a pair of selective gas outlet ports connected, either, to the gas inlet of the second electrode 12 of each cell and, the other, via an oxidizer branch line 19 to the gas inlet of the first electrode 11 of each cell. The oxidizer source may have an air compressor or blower.

The fuel cell system FC1 includes a purge system 21, which has a purge gas supply line for supplying a purge gas (air or inert gas such as nitrogen). The purge gas supply line has a two-port solenoid valve installed therein as a purge valve 22, which has a gas inlet port connected to a purge gas source, and a gas outlet port formed with a pair of gas outlets connected, either, via the fuel branch line 15 to the gas inlet of the second electrode 12 of each cell and, the other, via the oxidizer branch line 19 to the gas inlet of the first electrode 11 of each cell.

The fuel cell system FC1 includes an external electric circuit of the fuel cell body 10, which has a first load 24 connected in parallel via a switch 23 to the fuel cell body 10, a second load 26 connected in parallel via a switch 25 to the fuel cell body 10, and a voltage detector 27 connected in parallel to the fuel cell body 10. The detector 27 detects a voltage across the fuel cell body 10. In application to a fuel cell vehicle, the first load 24 may be an inverter for supplying an electric current to a vehicle-driving motor, and the second load 26 may be a DC(direct current)-to-DC(direct current) converter for charging a heater or low-voltage battery.

The fuel cell system FC1 includes a control system that governs the operation of fuel cell body 10, as well as operations of the entire system. The control system has a controller 28 for controlling the fuel supply system 13 (including fuel branch valve 14), the oxidizer supply system 17 (including oxidizer branch valve 18), the purge system 21 (including purge valve 22), and the switches 23, 25. The controller 28 is configured as a microprocessor with a CPU (central processing unit), memories, and I(input)/O(output) interfaces, although it is not limited thereto. The purge valve 22 is operated before each polarity change to be effected by operation of the branch valves 14, 18. The controller 28 receives a detection signal from the voltage detector 27, and calculates therefrom an average voltage difference between the first and second electrodes 11, 12 of each cell, as necessary, to make a decision on a finish condition of the electricity generation in the reverse polarity. The detection signal may well be processed to control a normal operation of the fuel cell body 10, e.g. for the electricity generation in the forward polarity.

As shown in FIG. 2, each cell has the electrolyte film 1 made of a solid high-polymer, which is active to transmit hydrogen ions (i.e. protons) in a water-containing state. At both sides of the electrolyte film 1, the first and second electrodes 11, 12 have their catalyst layers 2, 5 formed on the film 1, gas diffusion layers 3, 6, formed outside the layers 2, 5, and gas channels 5, 7 arranged for distribution of reactions gases over the layers 3, 6.

The electrolyte film 1 is adapted for proton transmission by use of a hermetic solid high-polymer material (e.g. fluorocarbon polymer). The catalyst layers 2, 5 have, at their electrolyte-contacting sides, catalyst particles made of Pt (platinum), Pt+Ru (ruthenium), or other applicable metals. The gas channels 4, 7 are defined by multiple ribs formed on either side or both sides of a hermetic material (e.g. very fine gas-tight carbon material).

For effective operation in a low-temperature state, it is necessary for the electrolyte film 1 to be sufficiently wet, and for the catalyst layer 2 of the first electrode 11 to have an amount of stored moisture commensurate to an amount of water to be transported, by ions accompanied therewith, to the second electrode 12. It is desirable for the catalyst layer 5 of the second electrode 12 (as well as gas diffusion layers 3, 6 and gas channels 4, 7 of both electrodes 11, 12) to be free of moisture.

The fuel cell system FC1 is operated as follows.

In a normal operation for electricity generation in forward polarity, the fuel gas is supplied from the fuel gas supply system 13 to the first electrode 11 of each cell, and the oxidizer is supplied from the oxidizer supply system 17 to the second electrode 12 of each cell. The fuel cell body 10 generates electricity in forward polarity. Used reaction gases are discharged through the discharge lines 16, 20. The switch 23 is close, and an electric current is conducted through the first load 24, where electric power is consumed.

For shutdown of the normal operation, the fuel and oxidizer supply systems 13, 17 are controlled to stop supplying reaction gases to the first and second electrodes 11, 12. The switch 23 of the first load 24 is opened. The purge system 21 is controlled to supply the purge gas through the purge valve 22, so that residual reaction gases are purged from associated gas lines, paths and channels.

The fuel branch valve 14 and the oxidizer branch valve 18 are operated, so that the fuel is supplied via the fuel branch line 15 to the second electrode 12, and the oxidizer is supplied via the oxidizer branch line 19 to the first eletrode 11. The switch 25 of the second load 26 is closed.

Electricity is generated at the fuel cell body 10 in a reverse polarity, where the first electrode 11 is polarized positive and the second electrode 12 is polarized negative, i.e., their polarities are reversed from the normal operation. The fuel cell body 10 has an electric current flowing in an opposite direction to the normal operation, which current is conducted through the second load 26.

At each cell of the fuel cell body 10, the second electrode 12 supplied with the fuel produces hydrogen ions, which are transmitted through the electrolyte film 1 to the first electrode 11. Those ions are accompanied with water molecules, so that moisture in the second electrode 12 is transported as accompanying water to the first electrode 11.

As the voltage detected by the voltage detector 27 falls below a threshold, the controller 28 makes a decision that a sufficient amount of moisture is transported from the second electrode 12 to the first electrode 11, and controls the fuel supply system 13 to stop fuel supply and the oxidizer supply system 17 to stop oxidizer supply. The switch 25 is opened.

It is noted that the second load 26 may be part of the first load 24. Unless this load 24 is adaptive for imposition of reverse voltage, a diode bridge may be installed between the load 24 and the fuel cell body 10.

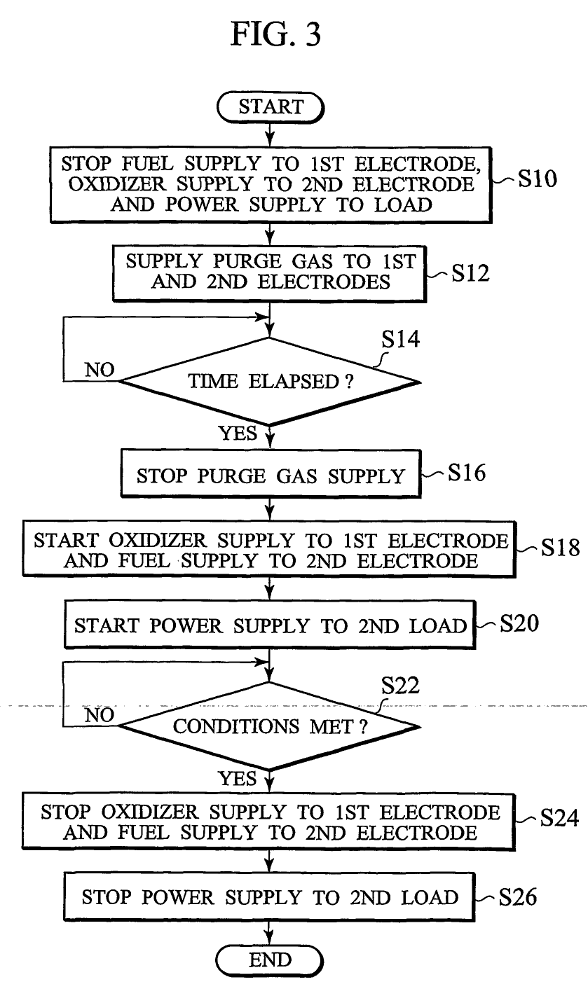

FIG. 3 shows, in flow chart, actions of the controller 28 for shutdown of the normal operation.

In FIG. 3, at a step S10, the CPU in the controller 28 gives a command so that fuel supply from system 13 to the first electrode 11 is stopped, oxidizer supply from system 17 to the second electrode 12 is stopped, and switch 23 is opened to interrupt power supply to the first load 24.

At a subsequent step S12, purge valve 22 is opened to start supplying purge gas to the first and second electrodes 11, 12.

At a decision step S14, purge gas supply is kept until a preset time elapses from the start of the supply. The time to elapse may be empirically determined and stored in a memory of the controller 28. With the lapse of time, gas channels 4, 7 and diffusion layers 3, 6 of the first and second electrodes 11, 12 are well purged of moisture. By this decision, the control flow goes to a step S16.

At the step S16, purge valve 22 is closed to stop purge gas supply to the first and second electrodes 11, 12.

At a subsequent step S18, branch valves 14, 18 are operated to start supplying fuel via fuel branch line 15 to the second electrode 12 and oxidizer via oxidizer branch line 19 to the first electrode 11.

At a step S20, switch 25 is closed to start power supply to the second load 26. Fuel cell body 10 is now controlled to start the generation of electricity in a reverse polarity to the normal operation, so that the first electrode 11 is polarized positive and the second electrode 12 is polarized negative. In each cell of fuel cell body 10, at the second electrode 12, hydrogen is ionized so that hydrogen ions are produced, which are transmitted, together with accompanying water molecules, through electrolyte film 1 to the first electrode 11, whereby moisture in catalyst layer 5 of the second electrode 12 is transported to catalyst layer 2 of the first electrode 11.

At a decision step S22, it is decided whether (a) finish condition(s) of the electricity generation in reverse polarity is (are) met. In this embodiment, decision is made if a voltage across fuel cell body 10, as measured by voltage detector 27, is decreased below a threshold. This is because, as moisture in catalyst layer 5 of the second electrode 12 is transported to the first electrode 11, the amount of moisture is decreased in the catalyst layer 5, where hydrogen has a an increased difficulty in ionization, and concurrently therewith, the water content of electrolyte film 1 is decreased at the second electrode side, decreasing the mobility of hydrogen ion, so that the electricity generation in reverse polarity has a reduced voltage.

As the finish condition is met at the step S22, the flow goes to a step S24, where the oxidizer supply to the first electrode 11 and the fuel supply to the second electrode 12 are stopped.

At a subsequent step S26, the switch 25 is opened to interrupt power supply to the second load 26. The shutdown of system FC1 is completed.

Resultant distribution of moisture in each cell is favorable for startup of the system FC1 under a low-temperature condition. Such a moisture distribution is achieved without excessive fuel consumption for electricity generation in reverse polarity, and without excessive moisture transportation from the second electrode 12 to the first electrode 11.

At the steps S24 and S26, the oxidizer supply, fuel supply, and power supply to load are stopped in the described order, which may be changed as circumstances require.

At the decision step S22, the finish condition of electricity generation in reverse polarity may be confirmation of a quantity of electric charges produced by electricity generation in reverse polarity, as it is estimated to be commensurate to a required amount of moisture to be transported from the second electrode 12 to the first electrode 11.

In this case, the necessary time t for the finish condition to be met may preferably be determined from the required amount Qw of moisture to be transported, the number n of accompanying water molecules per hydrogen ion that depends on a property of the electrolyte film 1, and the magnitude i_{g} of electric current to be conducted through the second load 26 by electricity generation in reverse polarity, such that:
t=k×Qw/(n×i_{g} (3),
where k is a constant coefficient that depends on the charge of electron and the unit system to be employed.

### Second Embodiment

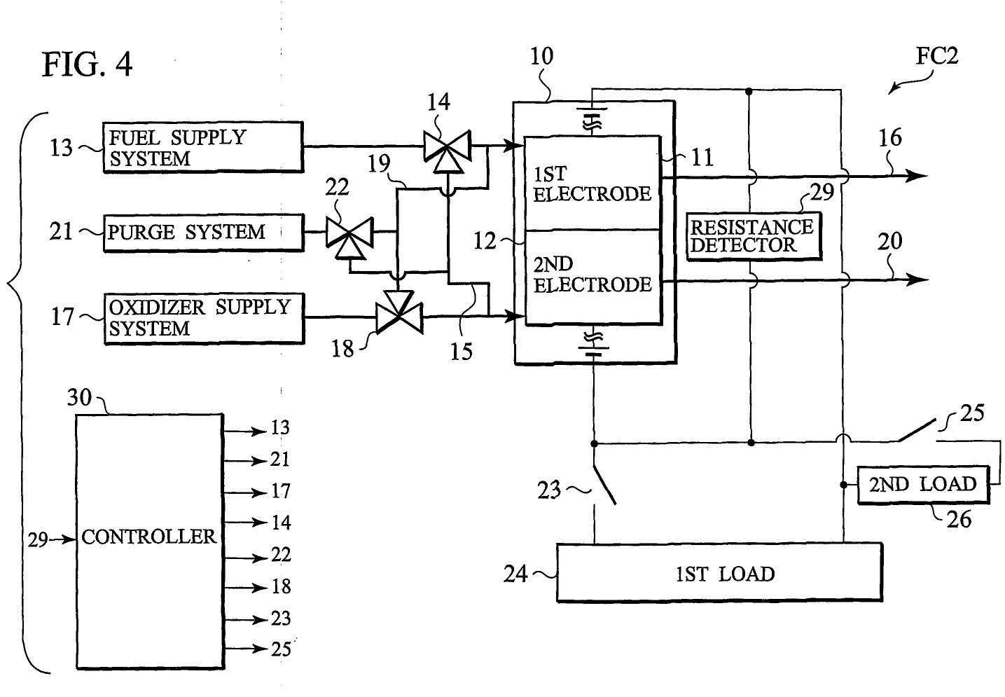

FIG. 4 shows, in block diagram, the arrangement of a solid polymer electrolyte fuel cell system FC2 adapted for outdoor use, in particular to fuel cell vehicles and the like, according to a second embodiment of the invention. For a section of each cell, refer to FIG. 2.

This system FC2 is different from the above noted system FC1 that the magnitude (Ω) of a total impedance of a fuel cell body 10 is detected (to check for a variation in average impedance value between a first electrode 11 and a second electrode 12 of each cell), for a decision to determine a timing to finish generation of electricity in reverse polarity.

That is, by imposing an ac voltage on an interconnecting circuit between a second load 26 and the fuel cell body 10 in generation of electricity in reverse polarity, a resistance detector 29 measures an ac current flowing the circuit, to thereby detect an impedance value of the fuel cell body 10.

In the system FC2, a controller 30 receives a detected impedance value from the detector 29, and calculates an average impedance value of each cell, if necessary, for a decision on the finish condition of electricity generation in reverse polarity.

A high-polymer electrolyte film 1 (FIG. 2), to be wet to transmit hydrogen ions, has an increasing resistance when drying, which nature is based on to make the decision on finish condition of electricity generation in reverse polarity.

If the impedance value detected by detector 29 exceeds a threshold, with a decision that a sufficient amount of moisture is transported from the second electrode 12 to the first electrode 11, the supply of fuel and oxidizer is stopped, and a switch of the second load 26 is opened. The threshold may be empirically determined, and stored in a memory of the controller 30.

Also in this system FC2, resultant distribution of moisture in each cell is favorable for system startup under a low-temperature condition. Such a moisture distribution is achieved without excessive fuel consumption for the electricity generation in reverse polarity, and without excessive moisture transportation from the second electrode 12 to the first electrode 11.

For control actions in the system FC2, refer to FIG. 3. This system FC2 is different from the before-mentioned system FC1 in that, at the step S22 of FIG. 3, the decision for the finish condition to be met is made if the impedance value of fuel cell body 10, as detected by detector 29, exceeds the threshold.

### Third Embodiment

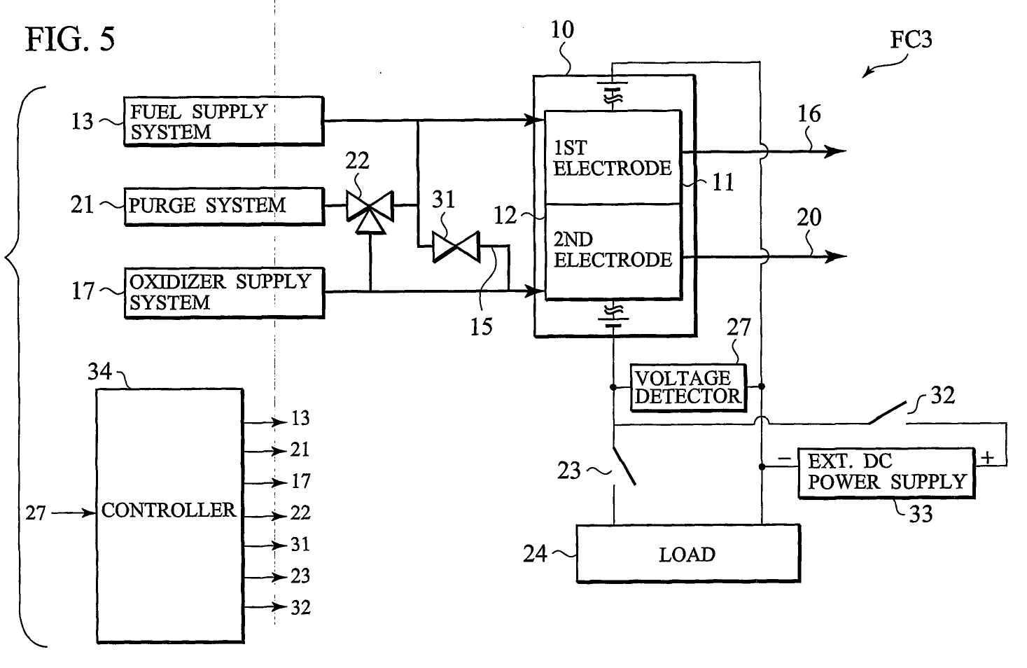

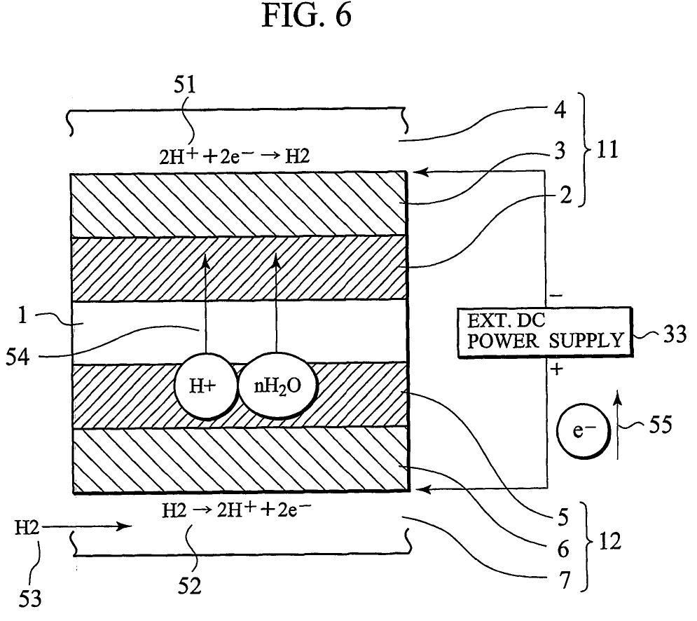

FIG. 5 shows, in block diagram, the arrangement of a solid polymer electrolyte fuel cell system FC3 adapted for outdoor use, in particular to fuel cell vehicles and the like, according to a third embodiment of the invention, and FIG. 6 shows a section of a cell (11/1/12) of a fuel cell body 10 of the fuel cell system FC3.

The system FC3 is simplified in gas connection, and has a drive (33) for polarity change.

This system FC3 features performing, after a stop of generation of electricity in a forward polarity, conduction of an electric current in a reverse direction, or current conduction (by an imposed voltage) in a reverse polarity, to move hydrogen ions in an opposite direction.

That is, at the shutdown of a normal operation of the system FC3 for the generation of electricity in the forward polarity in which a fuel (hydrogen) is supplied to a first electrode 11 and an oxidizer (air) is supplied to a second electrode 12, gas channels 4, 7 of the first and second electrodes 11, 12 are purged by a purge gas, removing moisture from gas diffusion layers 3, 6, and thereafter, the second electrode 12 is supplied with fuel. Then, for the current conduction in the reverse polarity, an external dc power supply 33 is connected to impose a voltage on the fuel cell body 10, having, in each cell, an electric field developed with a distribution of potential to be (lower in level and) negative (in polarity) at the first electrode 11 and (higher in level and) positive (in polarity) at the second electrode 12, with a potential gradient therebetween to be reverse to the normal operation. Thereby, through a high-polymer electrolyte film 1, hydrogen ions are moved in an opposite direction to the normal operation, so that protons current in this direction. As the hydrogen ions are accompanied with water molecules, moisture in the second electrode 12 is transported to the first electrode 11.

As shown in FIG. 6, at the second electrode 12 supplied with fuel as hydrogen molecules 53, these molecules are ionized by a reaction 52 to provide hydrogen ions, which are transmitted by the electric field developed with an imposed voltage from the dc power supply 33, through the electrolyte film 1 to the first electrode 11, so that water molecules accompanying the hydrogen ions move from the second electrode 12 to the first electrode 11. At the first electrode 11, arriving hydrogen ions are changed to hydrogen molecules by a reaction 51, where they are combined with electrons supplied there from the dc power supply 33, as the electrons are conducted in an opposite direction 55 to the electric current.

Returning to FIG. 5, the fuel cell system FC3 includes: the fuel cell body 10, which is made by a plurality of serially connected cells each respectively formed, as shown in FIG. 6, with the first and second electrodes 11, 12 and the high-polymer electrolyte film 1 interposed therebetween; a fuel supply system 13, which has a fuel supply line for supplying a fuel (hydrogen) as a reaction gas to a gas inlet of the first electrode 11 of each cell; and an oxidizer supply system 17, which has an oxidizer supply line for supplying an oxidizer (air) as another reaction gas to a gas inlet of the second electrode 12 of each cell. The fuel supply line of fuel supply system 13 and the oxidizer supply line of oxidizer supply system 17 may have their main and subsidiary gas supply valves governed by a later-described controller 34.

Like the system FC1, the gas inlet of the first electrode 11 communicates with a multiplicity of gas channels 4 (of which one is shown at the top of FIG. 6), which further communicate with a gas outlet of the first electrode 11, which is connected to a used gas discharge line 16 in FIG. 5. Also the gas inlet of the second electrode 12 communicates with a multiplicity of gas channels 7 (of which one is shown at the bottom of FIG. 6), which further communicate with a gas outlet of the second electrode 12, which is connected to a used gas discharge line 20 in FIG. 5.

The fuel supply line is provided with a fuel branch line 15, which has a two-port solenoid valve installed therein as a fuel valve 31 that has a gas inlet port connected to the fuel supply line, and a gas outlet port connected to the oxidizer supply line. The fuel valve 31 serves for fuel supply to the second electrode 12 during shutdown after normal operation of the system FC3.

Also the fuel cell system FC3 includes a purge system 21, which has a purge gas supply line for supplying a purge gas (air or inert gas such as nitrogen). The purge gas supply line has a two-port solenoid valve installed therein as a purge valve 22, which has a gas inlet port connected to a purge gas source, and a gas outlet port formed with a pair of gas outlets connected, either, via the fuel branch line 15 to the gas inlet of the first electrode 11 of each cell and, the other, via the oxidizer supply line to the gas inlet of the second electrode 12 of each cell.

The fuel cell system FC3 includes an external electric circuit of the fuel cell body 10, which has a load 24 connected in parallel via a switch 23 to the fuel cell body 10, a voltage detector 27 connected in parallel to the fuel cell body 10, for detecting a voltage thereacross, and the external dc power supply 33 connected in parallel via a switch 32 to the fuel cell body 10.

The dc power supply 33 supplies a voltage within a range of approx. 50 mV to approx. 100 mV per cell of the fuel cell body 10, that is sufficiently low relative to a voltage by electricity generation of the fuel cell body 10.

The quantity Q of electric charges to be supplied from the dc power supply 33 for each system shutdown has a relationship to the mol number m of water to be transported from the second electrode 12 to the first electrode 11 for the shutdown, such that:
Q=(m×e)/n (4),
where n is the number of accompanying water molecules per hydrogen ion that depends on a property of the electrolyte film 1, and e is the quantity of electric charge of electron.

The current i_{c} to be supplied from the dc power supply 33 can be expressed such that:
i_{c}=Q/t (5),
where t is the time of current conduction in reverse direction.

In application to a fuel cell vehicle, the external dc power supply 33 may be a combination of a boosting DC/DC converter and a low-voltage (e.g. 12V, 24V, or 36V) battery for auxiliary equipment of the vehicle or the fuel cell, or combination of a DC/DC converter and a capacitor.

The fuel cell system FC3 also includes a control system governing the operation of fuel cell body 10, as well as operations of the entire system. The control system has the controller 34, which is adapted, in the system shutdown as well, for controlling the fuel supply system 13 (including fuel valve 31), the oxidizer supply system 17, the purge system 21 (including purge valve 22), the switches 23, 32, and the dc power supply 33. The controller 28 is configured as a microprocessor with a CPU, memories, and I/O interfaces, although it is not limited thereto. The purge valve 22 is operated before each polarity change to be effected by valve and switch operations. The controller 34 receives a detection signal from the voltage detector 27, and calculates therefrom an average voltage difference between the first and second electrodes 11, 12 of each cell, as necessary, to make a decision on the finish condition of the current conduction in the reverse polarity. The detection signal may well be processed to control a normal operation of the fuel cell body 10, e.g. for the electricity generation in the forward polarity.

The fuel cell system FC3 is operated as follows.

In a normal operation for electricity generation in forward polarity, the fuel gas is supplied from the fuel gas supply system 13 to the first electrode 11 of each cell, and the oxidizer is supplied from the oxidizer supply system 17 to the second electrode 12 of each cell. Used reaction gases are discharged through the discharge lines 16, 20. The switch 23 is close, and an electric current is conducted through the load 24, where electric power is consumed.

For shutdown of the normal operation, the fuel and oxidizer supply systems 13, 17 are controlled to stop supply of reaction gases to the first and second electrodes 11, 12. The switch 23 of the load 24 is opened. The purge system 21 is controlled to supply the purge gas through the purge valve 22, so that residual reaction gases are purged from associated gas lines, paths and channels.

The fuel valve 31 is operated, so that the fuel is supplied via the fuel branch line 15 to the second electrode 12. The switch 32 of the dc power supply 33 is closed.

With a voltage imposed from the dc power supply 33, the first electrode 11 has a ‘negative’ potential (in terms of a ‘lower’ potential) and the second electrode 12 has a ‘positive’ potential (in terms of a ‘higher’ potential), so that the external circuit of fuel cell body 10 has an electric current conducted in an opposite direction to the normal operation.

At each cell of the fuel cell body 10, the second electrode 12 supplied with fuel produces hydrogen ions (protons), which are transmitted through the electrolyte film 1 to the first electrode 11. The hydrogen ions are accompanied with water molecules, so that residual moisture in the second electrode 12 is transported as accompanying water to the first electrode 11.

As the voltage detected by the voltage detector 27 exceeds a threshold, the controller 34 makes a decision that a sufficient amount of residual moisture is transported from the second electrode 12 to the first electrode 11, causing the electrolyte film 1 to start drying near the second electrode 12, and controls the fuel supply system 13 to stop fuel supply. The switch 32 is opened. The threshold may be empirically determined and stored in a memory of the controller 34.

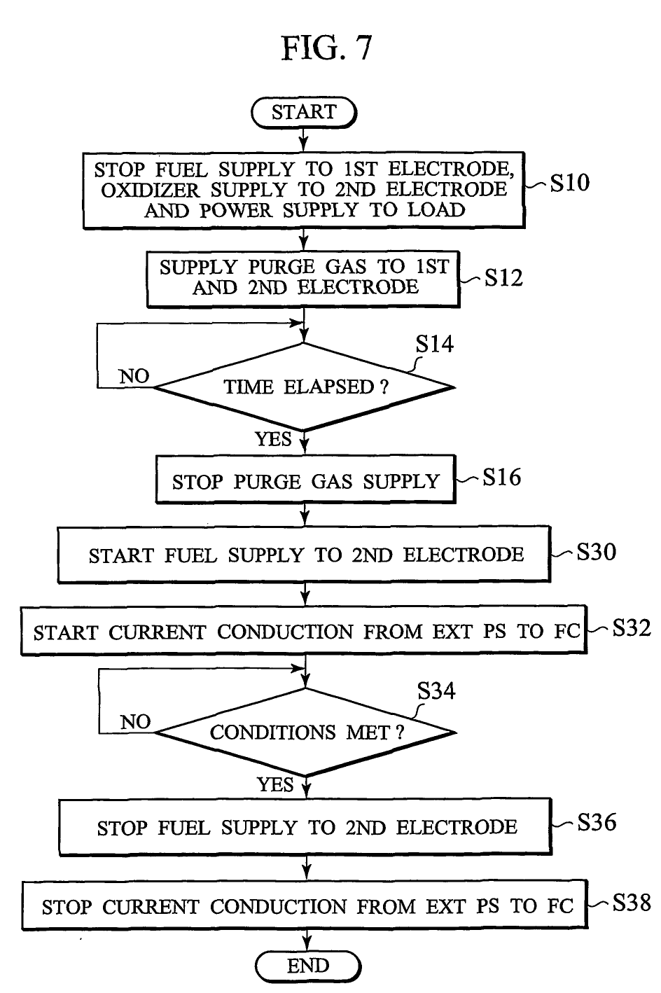

FIG. 7 shows, in flow chart, actions of the controller 34 for shutdown of the normal operation.

In FIG. 7, at steps S10, S12, S14, and S16, associated actions are analogous to those of FIG. 3. S16.

At a subsequent step S30, fuel valve 31 is operated to start supplying fuel from fuel supply system 13 via fuel branch line 15 to the second electrode 12.

At a step S32, switch 32 is closed to start driving fuel cell body 10 with a voltage imposed thereon from external dc power supply 33, so that, at each cell, the first electrode 11 has a negative potential and the second electrode 12 has a positive potential. Fuel cell body 10 has a dc current conducted thereto from dc power supply 33 in an opposite direction to the normal operation.

In each cell of fuel cell body 10, at the second electrode 12, hydrogen is ionized so that hydrogen ions are produced, which are transmitted, together with accompanying water molecules, through electrolyte film 1 to the first electrode 11, whereby moisture contained in catalyst layer 5 of the second electrode 12 is transported to catalyst layer 2 of the first electrode 11.

At a decision step S34, it is decided whether (a) finish condition(s) of the current conduction in reverse direction is (are) met. In this embodiment, decision is made if a voltage across fuel cell body 10, as measured by voltage detector 27, is in excess of a threshold. This is because, as moisture in catalyst layer 5 of the second electrode 12 is transported to the first electrode 11, the amount of moisture is decreased in the catalyst layer 5, where hydrogen has a an increased difficulty in ionization, and concurrently therewith, the water content of electrolyte film 1 is decreased at the second electrode side, decreasing the mobility of hydrogen ion, so that the current conduction in reverse direction has an increased voltage.

As the finish condition is met at the step S34, the flow goes to a step S36, where the fuel supply to the second electrode 12 is stopped.

At a subsequent step S38, the switch 32 is opened to interrupt the current conduction from dc power supply 33 to fuel cell body 10. The shutdown of system FC3 is completed.

Resultant distribution of moisture in each cell is favorable for startup of the system FC3 under a low-temperature condition. Such a moisture distribution is achieved without excessive fuel consumption for moisture transportation, and without excessive moisture transportation from the second electrode 12 to the first electrode 11.

At the steps S36 and S38, the fuel supply and power supply to load are stopped in the described order, which may be changed as circumstances require.

At the decision step S34, the finish condition of current conduction in reverse direction may be confirmation of a quantity of electric charges conducted in the reverse direction, as it is estimated to be commensurate to a required amount of moisture to be transported from the second electrode 12 to the first electrode 11, after the purge of moisture up to the step S16.

In this case, the necessary time t for the finish condition to be met may preferably be determined from the required amount Qw of moisture to be transported, the number n of accompanying water molecules per hydrogen ion that depends on a property of the electrolyte film 1, and the magnitude i_{c} of electric current to be conducted in the reverse direction from the external dc power supply 33 to the fuel cell body 10, such that:
t=k×Qw/(n×i_{c}) (6),
where k is a constant coefficient that depends on the charge of electron and the unit system to be employed.

### Fourth Embodiment

FIG. 4 shows, in block diagram, the arrangement of a solid polymer electrolyte fuel cell system FC4 adapted for outdoor use, in particular to fuel cell vehicles and the like, according to a fourth embodiment of the invention. For a section of each cell, refer to FIG. 6.

This system FC4 is different from the above-noted system FC3 in that the magnitude (Ω) of a total impedance of a fuel cell body 10 is detected (to check for a variation in average impedance value between a first electrode 11 and a second electrode 12 of each cell), for a decision to determine a timing to finish current conduction in reverse direction.

That is, by imposing an ac voltage on an interconnecting circuit between an external dc power supply 33 and the fuel cell body 10 in current conduction in reverse direction, a resistance detector 29 measures an ac current flowing the circuit, to thereby detect an impedance value of the fuel cell body 10.

In the system FC4, a controller 35 receives a detected impedance value from the detector 29, and calculates an average impedance value of each cell, if necessary, for a decision on the finish condition of current conduction in reverse direction.

A high-polymer electrolyte film 1 (FIG. 6), to be wet to transmit hydrogen ions, has an increasing resistance when drying, which nature is based on to make the decision on finish condition of current conduction in reverse direction.

If the impedance value detected by detector 29 exceeds a threshold, with a decision that a sufficient amount of moisture is transported from the second electrode 12 to the first electrode 11, causing the electrolyte to start drying near the second electrode 12, the supply of fuel is stopped, and a switch 32 of the dc power supply 33 is opened. The threshold may be empirically determined, and stored in a memory of the controller 35.

Also in this system FC4, resultant distribution of moisture in each cell is favorable for system startup under a low-temperature condition. Such a moisture distribution is achieved without excessive fuel consumption for moisture transportation, and without excessive moisture transportation from the second electrode 12 to the first electrode 11.

For control actions in the system FC4, refer to FIG. 7. This system FC4 is different from the before-mentioned system FC3 in that, at the step S34 of FIG. 7, the decision for the finish condition to be met is made if the impedance value of fuel cell body 10, as detected by detector 29, exceeds the threshold.

As will be seen from the foregoing description, in any of the first to fourth embodiments, a solid polymer electrolyte fuel cell system (FC1, FC2, FC3, FC4) comprises: a fuel cell body (10, 16, 20) configured with a high-polymer electrolyte film (1), and first and second electrodes (11, 12) with the high-polymer electrolyte film (1) in between; a fuel supply system (13) configured to supply a fuel to the first electrode (11) in a normal operation of the fuel cell body (10); an oxidizer supply system (17) configured to supply an oxidizer to the second electrode (12) in the normal operation of the fuel cell body (10); and an auxiliary system (14, 15, 18, 19, 21, 22, 23, 24, 25, 26, 27, 28, 29, 30, 31, 32, 33, 34, 35) adapted to transport residual moisture in (a catalyst layer 5 of) the second electrode (12) to (a catalyst layer 2 of) the first electrode (11) through the high-polymer electrolyte film (1).

The auxiliary system may appear as moisture transporting means for transporting moisture from the second electrode (12) to the first electrode (11) through the high-polymer electrolyte film (1).

In each embodiment (FC1, FC2, FC3, FC4), the auxiliary system is configured to transport moisture as water accompanying hydrogen ions from the second electrode (12) to the first electrode (11).

In the first and second embodiments (FC1, FC2), the auxiliary system comprises a fuel branch line (15) configured to supply the fuel from the fuel supply system (13) to the second electrode (12), and an oxidizer branch line (19) configured to supply the oxidizer to the first electrode (11).

In the first and third embodiments (FC1, FC3), the auxiliary system comprises a voltage detector (27) configured to detect a voltage across the fuel cell body (10). The voltage to be detected may be across a cell (11/1/12).

In the second and fourth embodiments (FC2, FC4), the auxiliary system comprises a resistance detector (29) configured to detect an impedance value of the fuel cell body (10). The impedance value to be detected may be between the first and second electrodes (11, 12) of a cell.

In the third and fourth embodiments (FC3, FC4), the auxiliary system comprises a fuel branch line (15) configured to supply the fuel from the fuel supply system (13) to the second electrode (12), and an external dc power supply (33) configured to apply a voltage between the first electrode (11) to be negative in polarity and the second electrode (12) to be positive in polarity.

In the first and second embodiments, an operation method for a solid polymer electrolyte fuel cell system (FC1, FC2) comprises, in a shutdown operation of the fuel cell system (FC1, FC2): an electricity generation interrupt step of stopping electric power supply to a load (24) of the fuel cell body (10), fuel supply to the first electrode (11), and oxidizer supply to the second electrode (12); a purge step of supplying a purge gas to the first and second electrodes (11, 12); and a reverse-polarity electricity-generation step of supplying the fuel via the fuel branch line (15) to the second electrode (12) and the oxidizer via the oxidizer branch line (19) to the first electrode (11), consuming (at a load 26) electric power generated at the fuel cell body (10).

In the first and second embodiments (FC1, FC2), the reverse-polarity electricity-generation step comprises: confirming a quantity of electric charges moved by an electric current due to electricity generation in a reverse polarity, as the quantity is estimated to be commensurate to a desirable quantity of moisture to be transported as water accompanying hydrogen ions; and stopping at least one of supplying the fuel via the fuel branch line (15) to the second electrode (12), supplying the oxidizer via the oxidizer branch line (19) to the first electrode (11), and consuming (at the load 26) electric power generated at the fuel cell body (10).

In the first embodiment, an operation method for a solid polymer electrolyte fuel cell system (FC1) comprises, in a shutdown operation of the fuel cell system (FC1): an electricity generation interrupt step of stopping electric power supply to a load (24) of the fuel cell body (10), fuel supply to the first electrode (11), and oxidizer supply to the second electrode (12); a purge step of supplying a purge gas to the first and second electrodes (11, 12); and a reverse-polarity electricity-generation step of supplying the fuel via the fuel branch line (15) to the second electrode (12) and the oxidizer via the oxidizer branch line (19) to the first electrode (11), consuming (at a load 26) electric power generated at the fuel cell body (10), wherein the reverse-polarity electricity-generation step comprises, when the voltage detected by the voltage detector (27) across the fuel cell body (10) is decreased below a threshold, stopping at least one of supplying the fuel via the fuel branch line (15) to the second electrode (12), supplying the oxidizer via the oxidizer branch line (19) to the first electrode (11), and consuming (at the load 26) electric power generated at the fuel cell body (10).

In the second embodiment, an operation method for a solid polymer electrolyte fuel cell system (FC2) comprises, in a shutdown operation of the fuel cell system (FC2): an electricity generation interrupt step of stopping electric power supply to a load (24) of the fuel cell body (10), fuel supply to the first electrode (11), and oxidizer supply to the second electrode (12); a purge step of supplying a purge gas to the first and second electrodes (11, 12); and a reverse-polarity electricity-generation step of supplying the fuel via the fuel branch line (15) to the second electrode (12) and the oxidizer via the oxidizer branch line (19) to the first electrode (11), consuming (at a load 26) electric power generated at the fuel cell body (10), wherein the reverse-polarity electricity-generation step comprises, when the impedance value of the fuel cell body (10) detected by the resistance detector (27) is increased above a threshold, stopping at least one of supplying the fuel via the fuel branch line (15) to the second electrode (12), supplying the oxidizer via the oxidizer branch line (19) to the first electrode (11), and consuming (at the load 26) electric power generated at the fuel cell body (10).

In the third and fourth embodiments, an operation method for a solid polymer electrolyte fuel cell system (FC3, FC4) comprises, in a shutdown operation of the fuel cell system (FC3, FC4): an electricity generation interrupt step of stopping electric power supply to a load (24) of the fuel cell body (10), fuel supply to the first electrode (11), and oxidizer supply to the second electrode (12); a purge step of supplying a purge gas to the first and second electrodes (11, 12); and a reverse-direction current-conduction step of supplying the fuel via the fuel branch line (15) to the second electrode (12), having a voltage imposed from the external dc power supply (33), on each cell, between the first electrode (11) to be negative in polarity and the second electrode (12) to be positive in polarity, thereby conducting an electric current (from the external dc power supply 33 to the fuel cell body 10) in an opposite direction (to the normal operation).

In the third and fourth embodiments (FC3, FC4), the reverse-direction current-conduction step comprises: confirming a quantity of electric charges moved by the conducted electric current, as the quantity is estimated to be commensurate to a desirable quantity of moisture to be transported as water accompanying hydrogen ions; and stopping at least one of supplying the fuel via the fuel branch line (15) to the second electrode (12) and conducting the electric current from the external dc power supply (33) to the fuel cell body (10).

In the third embodiment, an operation method for a solid polymer electrolyte fuel cell system (FC3) comprises, in a shutdown operation of the fuel cell system (FC3): an electricity generation interrupt step of stopping electric power supply to a load (24) of the fuel cell body (10), fuel supply to the first electrode (11), and oxidizer supply to the second electrode (12); a purge step of supplying a purge gas to the first and second electrodes (11, 12); and a reverse-direction current-conduction step of supplying the fuel via the fuel branch line (15) to the second electrode (12), having a voltage imposed from the external dc power supply (33), on each cell, between the first electrode (11) to be negative in polarity and the second electrode (12) to be positive in polarity, thereby conducting an electric current in an opposite direction, wherein the reverse-direction current-conduction step comprises, when the voltage detected by the voltage detector (27) across the fuel cell body (10) is increased above a threshold, stopping at least one of supplying the fuel via the fuel branch line (15) to the second electrode (12) and conducting the electric current from the external dc power supply (33) to the fuel cell body (10).

In the fourth embodiment, an operation method for a solid polymer electrolyte fuel cell system (FC4) comprises, in a shutdown operation of the fuel cell system (FC4): an electricity generation interrupt step of stopping electric power supply to a load (24) of the fuel cell body (10), fuel supply to the first electrode (11), and oxidizer supply to the second electrode (12); a purge step of supplying a purge gas to the first and second electrodes (11, 12); and a reverse-direction current-conduction step of supplying the fuel via the fuel branch line (15) to the second electrode (12), having a voltage imposed from the external dc power supply (33), on each cell, between the first electrode (11) to be negative in polarity and the second electrode (12) to be positive in polarity, thereby conducting an electric current in an opposite direction, wherein the reverse-direction current-conduction step comprises, when the impedance value of the fuel cell body (10) detected by the resistance detector (29) is increased above a threshold, stopping at least one of supplying the fuel via the fuel branch line (15) to the second electrode (12) and conducting the electric current from the external dc power supply (33) to the fuel cell body (10).

In each embodiment, the catalyst layers 2 and 5 provided on both sides of electrolyte film 1 have their catalyst particles, which can serve, at either side of the film 1, for efficient ionization of hydrogen molecules contacting therewith, as they are diffused through diffusion layer 3 or 6 of the first or second electrode 11 or 12, where the fuel is supplied.

In the first and second embodiments, the first and second electrodes 11, 12 have their polarities reversed by exchanged supply connections of fuel and oxidizer, so that each cell (supplied at the first electrode 11 with oxidizer and at the second electrode 12 with fuel) works as a fuel cell adapted to produce a sufficient electromotive force with a reverse polarity, to allow for hydrogen ions to be drifted in a reverse direction to a normal operation of the system.

In the third and fourth embodiments, after a gas purge to be effective at both sides of electrolyte film 1, mere the fuel has a changed supply end (as the oxidizer remains off), so that each cell is adapted, at the fuel supply end (i.e. at the second electrode 12), to generate hydrogen ions, but the cell is unable to produce an effective electromotive force. Therefore, each cell is driven from an external dc power supply 33 adapted to provide an electromotive force as necessary, to drift generated hydrogen ions in a reverse direction.

It is noted that in each embodiment, hydrogen ions accompanied with water molecules are moved in a reverse direction, allowing for a resultant distribution of moisture in each cell to be optimized for any purpose, e.g. for a low-temperature restart of the system.

Further, in each embodiment, electrons are conducted from the second electrode (12) to the first electrode (11), i.e. an electric current is conducted from the first electrode (11) to the second electrode (12), via an external circuit (25, 26 or 32, 33) of the fuel cell body (10), by an electromotive force that is produced in the fuel cell body (10) in the first and second embodiments (FC1, FC2), or that is produced in the external circuit (32, 33) in the third and fourth embodiments (FC3, FC4).

It also is noted that in each embodiment, hydrogen ions are activated into movement along a potential gradient developed by the above-noted electromotive force, and inactivated by a loss thereof.

The contents of patent application 2002-346409 filed on Nov. 28, 2002, in the Japanese Patent Office are incorporated herein by reference.

While embodiments of the present invention have been described using specific terms, such description is for illustrative purposes, and it is to be understood that changes and variations may be made without departing from the scope or spirit of the following claims.

### INDUSTRIAL APPLICABILITY

The present invention is applicable to a solid polymer electrolyte fuel cell system and an operation method therefor, to allow a system shutdown after a normal operation to be adapted for an improved restart under a low-temperature condition or with a favorable distribution of moisture in each cell.

1. A solid polymer electrolyte fuel cell system (FC1; FC2; FC3; FC4) comprising:
a fuel cell (10, 13, 16, 17, 20) configured to generate electricity with an electrolyte film (1) interposed between a first electrode (11) supplied with a fuel and a second electrode (12) supplied with an oxidizer; and
a moisture transport system (14, 15, 18, 19, 21, 22, 23, 24, 25, 26, 27, 28; 14, 15, 18, 19, 21, 22, 23, 24, 25, 26, 29, 30; 15, 21, 22, 23, 24, 27, 31, 32, 33, 34; 15, 21, 22, 23, 24, 29, 31, 32, 33, 35) configured to transport moisture from the second electrode (12) to the first electrode (11) through the electrolyte film (1):

2. A solid polymer electrolyte fuel cell system (FC1; FC2; FC3; FC4) according to claim 1, wherein the moisture transport system comprises:
an ion generating system (14, 15, 21, 22; 14, 15, 21, 22; 15, 21, 22; 15, 21, 22) configured to generate an ion to be accompanied with a fraction of moisture at the second electrode (12); and
an ion moving system (18, 19, 25, 26; 14, 15, 18, 19, 21, 22, 25, 26; 15, 21, 22, 31, 32, 33; 15, 21, 22, 31, 32, 33) configured to move the ion to the first electrode (11).

3. A solid polymer electrolyte fuel cell system (FC1; FC2; FC3; FC4) according to claim 2, wherein the ion generating system comprises a fuel line (14, 15; 14, 15; 15, 31; 15, 31) configured to supply the fuel to the second electrode (12).

4. A solid polymer electrolyte fuel cell system (FC1; FC2) according to claim 3, wherein the ion moving system comprises:
an oxidizer line (18, 19) configured to supply the oxidizer to the first electrode (11); and
an external circuit (25, 26) configured to interconnect the first and second electrodes (11, 12).

5. A solid polymer electrolyte fuel cell system (FC3; FC4) according to claim 3, wherein the ion moving system comprises:
an external voltage source (33) configured to generate a dc voltage; and
an external circuit (32) connected to the first and second electrodes (11, 12) and configured to impose the dc voltage therebetween.

6. A solid polymer electrolyte fuel cell system (FC1; FC2; FC3; FC4) according to claim 2, wherein the moisture transport system further comprises an ion inactivating system (27, 28; 29, 30; 27, 34; 29, 35) configured to inactivate the ion to stop moving to the first electrode (11).

7. A solid polymer electrolyte fuel cell system (FC1; FC3) according to claim 6, wherein the ion inactivating system comprises:
a voltage detector (27) configured to detect a representative voltage representative of a voltage between the first and second electrodes (11, 12); and
a controller (28; 34) configured to control the ion moving system (18, 19, 25, 26; 15, 21, 22, 31, 32, 33) in response to the representative voltage.

8. A solid polymer electrolyte fuel cell system (FC2; FC4) according to claim 6, wherein the ion inactivating system comprises:
an impedance detector (29) configured to detect a representative impedance representative of an impedance between the first and second electrodes (11, 12); and
a controller (30; 35) configured to control the ion moving system (14, 15, 18, 19, 21, 22, 25, 26; 15, 21, 22, 31, 32, 33) in response to the representative impedance.

9. A solid polymer electrolyte fuel cell system (FC1; FC2; FC3; FC4) comprising:
a fuel cell (10, 13, 16, 17, 20) for generating electricity with an electrolyte film (1) interposed between a first electrode (11) supplied with a fuel and a second electrode (12) supplied with an oxidizer; and
moisture transport means (14, 15, 18, 19, 21, 22, 23, 24, 25, 26, 27, 28; 14, 15, 18, 19, 21, 22, 23, 24, 25, 26, 29, 30; 15, 21, 22, 23, 24, 27, 31, 32, 33, 34; 15, 21, 22, 23, 24, 29, 31, 32, 33, 35) for transporting moisture from the second electrode (12) to the first electrode (11) through the electrolyte film (1).

10. An operation method for solid polymer electrolyte fuel cell systems (FC1; FC2; FC3; FC4), comprising:
generating electricity with an electrolyte film (1) interposed between a first electrode (11) supplied with a fuel and a second electrode (12) supplied with an oxidizer; and
transporting moisture from the second electrode (12) to the first electrode (11) through the electrolyte film (1).

11. An operation method for solid polymer electrolyte fuel cell systems (FC1; FC2; FC3; FC4) according to claim 10, wherein the transporting moisture comprises:
generating an ion at the second electrode (12);
accompanying the ion with a fraction of moisture; and
moving the ion to the first electrode (11).

12. An operation method for solid polymer electrolyte fuel cell systems (FC1; FC2; FC3; FC4) according to claim 11, wherein the generating the ion comprises supplying the fuel to the second electrode (12).

13. An operation method for solid polymer electrolyte fuel cell systems (FC1; FC2) according to claim 12, wherein the moving the ion comprises:
supplying the oxidizer to the first electrode (11); and
interconnecting the first and second electrodes (11, 12) by an external circuit (25, 26).

14. An operation method for solid polymer electrolyte fuel cell systems (FC3; FC4) according to claim 12, wherein the moving the ion comprises:
providing an external voltage source (33) generating a dc voltage; and
imposing the dc voltage between the first and second electrodes (11, 12), via an external circuit (32) connected thereto.

15. An operation method for solid polymer electrolyte fuel cell systems (FC1; FC2; FC3; FC4) according to claim 11, wherein the transporting moisture further comprises inactivating the ion to stop moving to the first electrode (11).

16. An operation method for solid polymer electrolyte fuel cell systems (FC1; FC3) according to claim 15, wherein the inactivating the ion comprises:
detecting a representative voltage representative of a voltage between the first and second electrodes (11, 12); and
controlling the moving the ion in response to the representative voltage.

17. An operation method for solid polymer electrolyte fuel cell systems (FC2; FC4) according to claim 15, wherein the inactivating the ion comprises:
detecting a representative impedance representative of an impedance between the first and second electrodes (11, 12); and
controlling the moving the ion in response to the representative impedance.

18. A solid polymer electrolyte fuel cell system (FC1; FC2; FC3; FC4) comprising:
a fuel cell (10, 13, 16, 17, 20) configured to generate electricity with an electrolyte film (1) interposed between a first electrode (11) supplied with a fuel and a second electrode (12) supplied with an oxidizer; and
a hydrogen ion moving system (14, 15, 18, 19, 21, 22, 23, 24, 25, 26, 27, 28; 14, 15, 18, 19, 21, 22, 23, 24, 25, 26, 29, 30; 15, 21, 22, 23, 24, 27, 31, 32, 33, 34; 15, 21, 22, 23, 24, 29, 31, 32, 33, 35) configured to move hydrogen ions from the second electrode (12) to the first electrode, (11) through the electrolyte film (1).

19. A solid polymer electrolyte fuel cell system (FC1; FC2; FC3; FC4) comprising:
a fuel cell (10, 13, 16, 17, 20) for generating electricity with an electrolyte film (1) interposed between a first electrode (11) supplied with a fuel and a second electrode (12) supplied with an oxidizer; and
hydrogen ion moving means (14, 15, 18, 19, 21, 22, 23, 24, 25, 26, 27, 28; 14, 15, 18, 19, 21, 22, 23, 24, 25, 26, 29, 30; 15, 21, 22, 23, 24, 27, 31, 32, 33, 34; 15, 21, 22, 23, 24, 29, 31, 32, 33, 35) for moving hydrogen ions from the second electrode (12) to the first electrode (11) through the electrolyte film (1).

20. An operation method for solid polymer electrolyte fuel cell systems (FC1; FC2; FC3; FC4), comprising:
generating electricity with an electrolyte film (1) interposed between a first electrode (11) supplied with a fuel and a second electrode (12) supplied with an oxidizer; and
moving hydrogen ions from the second electrode (12) to the first electrode (11) through the electrolyte film (1).
